(19) United States
(12) Patent Application Publication
(10) Pub. No.: US 2022/0413480 A1
(43) Pub. Date: Dec. 29, 2022

(54) TIME SERIES DATA PROCESSING METHOD

(71) Applicant: NEC Corporation, Minato-ku, Tokyo (JP)

(72) Inventor: Yohei IIZAWA, Tokyo (JP)

(73) Assignee: NEC Corporation, Minato-ku, Tokyo (JP)

(21) Appl. No.: 17/783,105

(22) PCT Filed: Dec. 25, 2019
(86) PCT No.: PCT/JP2019/050988

§ 371 Date: Jun. 7, 2022

(51) Int. Cl. G05B 23/02

(52) U.S. Cl. CPC G05B 23/0254; G05B 23/0221

(57) ABSTRACT

A time series data processing system according to the present invention includes a learning unit configured to learn so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data. The normal period is a period in which the measurement target is determined to be in a normal state. The anomalous period is a period in which the measurement target is determined to be in an anomalous state.

### TECHNICAL FIELD

The present invention relates to a time series data processing method, a time series data processing system, and a program.

### BACKGROUND ART

In industrial plants to manufacture energy (electricity, gas, clean water, and the like) and industrial products (mechanical products, chemical products, foods, pharmaceuticals, and the like) and equipment or large machines such as an information processing system, time series data that are values measured by various kinds of sensors are analyzed and the occurrence of an anomalous state is detected and output. Specifically, to detect an anomalous state, an anomaly model is first generated by machine learning of time series data measured in a monitoring target known to be in an anomalous state in advance, and it is determined whether or not time series data measured in a monitoring target later corresponds to the anomaly model.

Patent Document 1 describes a method for detecting a failure of machinery equipment. In Patent Document 1, first, a normality model is generated from sensor data in a normal state, and an anomaly model is generated from sensor data in an anomalous state. Then, sensor data is input into the normality model and the anomaly model to perform determination of an anomalous state.

Patent Document 1: Japanese Unexamined Patent Application Publication No. JP-A 2019-185422

However, the method of learning a normal state and an anomalous state as mentioned above causes a problem that an indication of the anomalous state cannot be properly detected in a boundary state, which is a period during which time series data is transiting from the normal state to the anomalous state. That is to say, in a boundary period between the normal state and the anomalous state, it cannot be detected which state a monitoring target is in.

On the other hand, it can also be considered to learn a period between a normal state and an anomalous state of time series data as an anomaly indication period and detect the anomaly indication period from new time series data. However, when the boundary period during which the data is transiting from the normal state to the anomalous state is a long time, an indication of the anomalous state is detected earlier, which precludes more proper detection of the indication of the anomalous state.

### SUMMARY

Accordingly, an object of the present invention is to provide a time series data processing method, a time series data processing system and a program that can solve the abovementioned problem that it is impossible to more properly detect an indication of an anomalous state.

A time series data processing method as an aspect of the present invention includes learning so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data. The normal period is a period in which the measurement target is determined to be in a normal state, The anomalous period is a period in which the measurement target is determined to be in an anomalous state.

Further, a time series data processing system as an aspect of the present invention includes a learning unit configured to learn so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data The normal period is a period in which the measurement target is determined to be in a normal state. The anomalous period is a period in which the measurement target is determined to be in an anomalous state.

Further, a computer program as an aspect of the present invention includes instructions for causing an information processing apparatus to realize

a learning unit configured to learn so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data, the normal period being a period in which the measurement target is determined to be in a normal state, the anomalous period being a period in which the measurement target is determined to be in an anomalous state.

With the configurations as described above, the present invention allows more proper detection of an indication that a target falls into an anomalous state.

### BRIEF DESCRIPTION OF DRAWINGS

FIG. 1 is a block diagram showing a configuration of a time series data processing system in a first example embodiment of the present invention;

FIG. 2 is a view showing an image of time series data processing by the time series data processing system disclosed in FIG. 1;

FIG. 3 is a view showing an image of time series data processing by the time series data processing system disclosed in FIG. 1; FIG. 4 is a view showing an image of time series data processing by the time series data processing system disclosed in FIG. 1;

FIG. 5 is a view showing an image of time series data processing by the time series data processing system disclosed in FIG. 1;

FIG. 6 is a flowchart showing an operation of the time series data processing system disclosed in FIG. 1;

FIG. 7 is a view showing an image of time series data processing by the time series data processing system disclosed in FIG. 1;

FIG. 8 is a view showing an image of time series data processing by the time series data processing system disclosed in FIG. 1;

FIG. 9 is a view showing an image of time series data processing by the time series data processing system disclosed in FIG. 1;

FIG. 10 is a view showing an image of time series data processing by the time series data processing system disclosed in FIG. 1;

FIG. 11 is a view showing an image of time series data processing by the time series data processing system disclosed in FIG. 1;

FIG. 12 is a view showing an image of time series data processing by the time series data processing system disclosed in FIG. 1;

FIG. 13 is a block diagram showing a hardware configuration of a time series data processing system in a second example embodiment of the present invention;

FIG. 14 is a block diagram showing a configuration of the time series data processing system in the second example embodiment of the present invention; and

FIG. 15 is a flowchart showing an operation of the time series data processing system in the second example embodiment of the present invention.

### EXAMPLE EMBODIMENTS

### First Example Embodiment

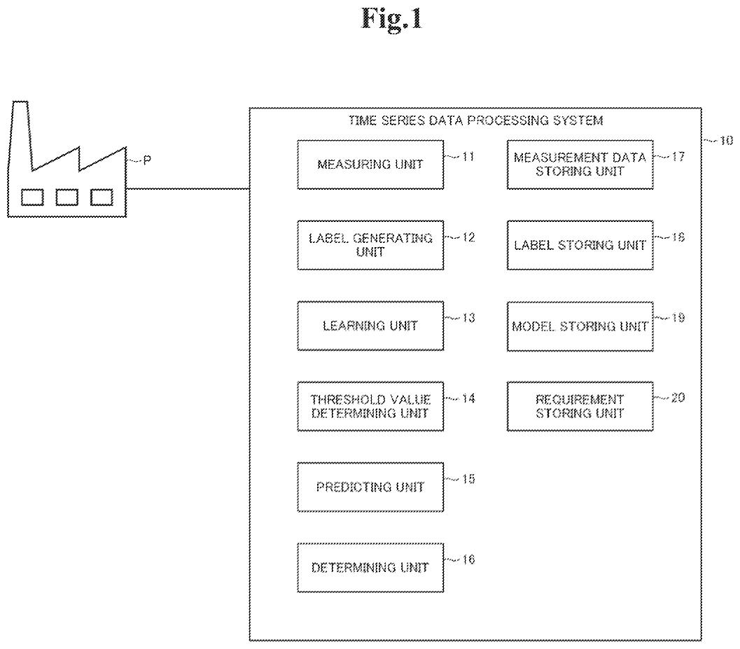

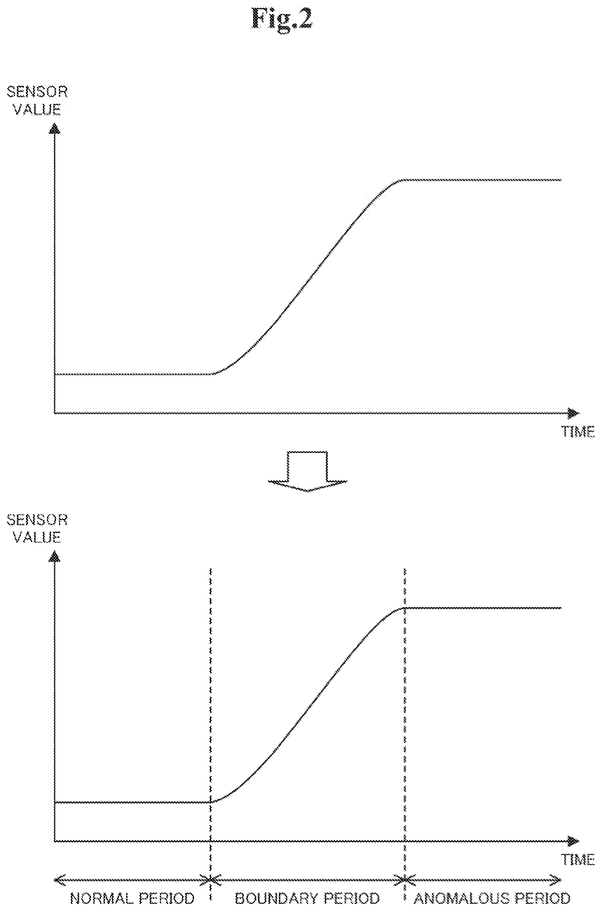

A first example embodiment of the present invention will be described with reference to FIGS. 1 to 12. FIG. 1 is a view for describing a configuration of a time series data processing system, and FIGS. 2 to 12 are views for describing a processing operation of the time series data processing system.

### [Configuration]

A time series data processing system 10 according to the present invention is connected to a measurement target P such as a plant. Then, the time series data processing system 10 acquires and analyzes the measurement value of at least one or more data items of the measurement target P, monitors the state of the measurement target P based on the analysis result, and detects a predetermined state. In particular, the time series data processing system 10 in this example embodiment performs machine learning of supervised learning such as a neural network or deep learning by using past measurement values, and detects the state of the measurement target P from a new measurement value of the measurement target P by using a model generated by the learning.

For example, the measurement target P is a plant such as a manufacture factory or a processing facility, and the measurement values of the respective data items include the values of a plurality of kinds of data items such as the temperature, pressure, flow rate, power consumption value, supply amount of raw material and remaining amount of raw material in the plant. However, the measurement target P whose state is monitored by the time series data processing system 10 of the present invention is not limited to a plant, and may be equipment or a large machine such as an information processing system. For example, in a case where the measurement target P is an information processing system, the state of the information processing system may be detected by measuring the CPU (Central Processing Unit) usage, memory usage, disk access frequency, number of input/output packets, input/output packet rate, power consumption value and so on of each of the information processing apparatuses such as a device and a server configuring the information processing system as the measurement values of the respective data items, and analyzing the measurement values. In a case where the measurement target P is a machine, the state of the machine may be detected by measuring measurement values such as torque and rotational speed caused by the movement of the components of the machine.

The time series data processing system 10 in this example embodiment is configured to not only detect the normal state and the anomalous state of the measurement target P as the state of the measurement target P but also particularly detect an indication of falling into the anomalous state. A configuration of the time series data processing system 10 will be described in detail below.

The time series data processing system 10 is configured by one or a plurality of information processing apparatuses including an arithmetic logic unit and a storage unit. The time series data processing system 10 includes, as shown in FIG. 1, a measuring unit 11, a label generating unit 12, a learning unit 13, a threshold value determining unit 14, a predicting unit 15, and a determining unit 16. The functions of the measuring unit 11, the label generating unit 12, the learning unit 13, the threshold value determining unit 14, the predicting unit 15, and the determining unit 16 can be realized by the arithmetic logic unit executing a program for realizing the respective functions stored in the storage unit. Moreover, the time series data processing system 10 includes a measurement data storing unit 17, a label storing unit 18, a model storing unit 19, and a requirement storing unit 20. The measurement data storing unit 17, the label storing unit 18, the model storing unit 19, and the requirement storing unit 20 are configured by the storage unit. The respective components will be described in detail below.

The measuring unit 11 acquires sensor values measured by various kinds of sensors installed in the measurement target P at predetermined time intervals as time series data, and stores into the measurement data storing unit 17. FIG. 2 shows an example of time series data acquired by the measuring unit 11 and processed by the time series data processing system 10. As shown in the upper view of FIG. 2, the time series data processing system 10 in this example embodiment processes time series data of one sensor value measured by one sensor. However, the time series data processing system 10 may process a time series data set including time series data of a plurality of kinds of data items.

The measuring unit 11 acquires time series data at all times. Then, as will be described later, the measuring unit 11 stores the acquired time series data as learning data used for generating a model for detecting an indication of an anomalous state of the measurement target P into the measurement data storing unit 17, or acquires the data as predicting data used at the time of predicting the state of the measurement target P and passes the data to the predicting unit 15.

The label generating unit 12 (generating unit) retrieves time series data that is learning data measured in the past from the measurement data storing unit 17, and performs a process for generating a model. Specifically, the label generating unit 12 first retrieves past time series data as shown in the upper view of FIG. 2, and sets a label representing a period corresponding to each state of the measurement target P on the time series data. At this time, the label generating unit 12 accepts an input of time information identifying a normal period in which the measurement target P is determined to be in a normal state and an anomalous period in which the measurement target P is determined to be in an anomalous state in the time series data, respectively, and sets a label of the normal state and a label of the anomalous state on time series data at times corresponding to the respective periods as shown in the lower view of FIG. 2. Then, in a case where there is another period between the label of the normal period and the label of the anomalous period in the time series data, the label generating unit 12 determines the other period between the normal state and the anomalous state as a boundary period in which the measurement target P is in a boundary state of transiting from the normal state to the anomalous state, and sets a label of the boundary period.

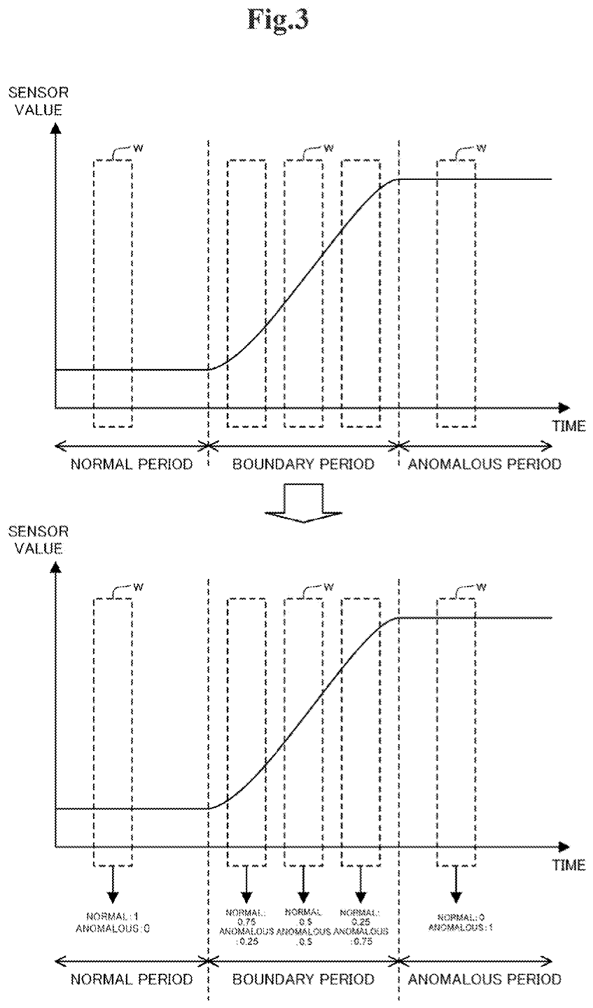

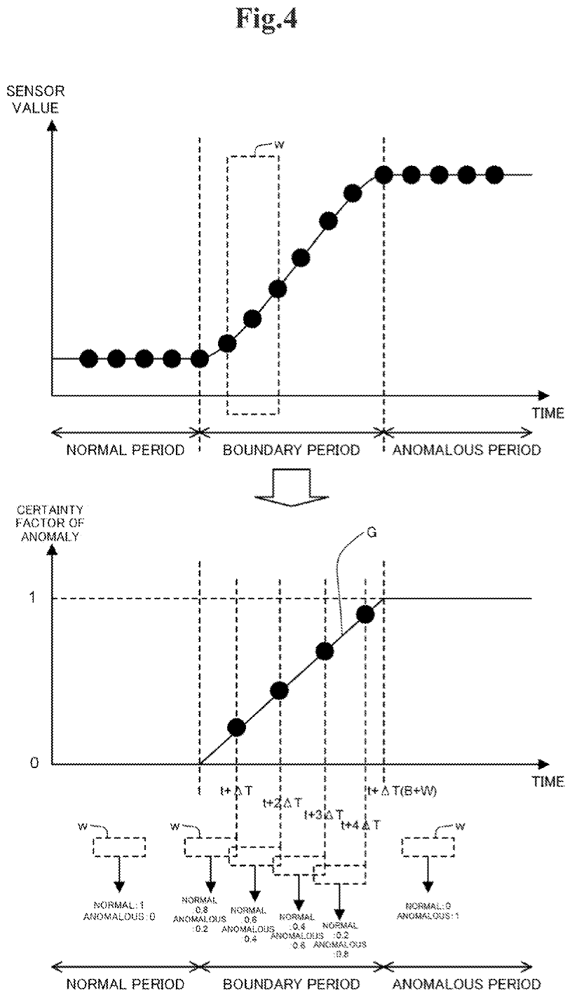

Subsequently, the label generating unit 12 extracts partial time series data having a predetermined time width from the time series data of each period, and generates label data in which the weight of a category representing the state of the measurement target P is associated with the partial time series data. Herein, a “normal state” and an “anomalous state” are set as “categories” representing the state of the measurement target P, and both a “certainty factor representing the degree of certainty of the normal state” and a “certainty factor representing the degree of certainty of the anomalous state” are set as “weights” of the respective categories. Specifically, the label generating unit 12 first sets a window w having a predetermined time width on the time series data of each period as shown in the upper view of FIG. 3. The time width, number, and slide width of the window w will be described later. Then, the label generating unit 12 generates label data by associating the weight of each category with the partial time series data in each window w in accordance with a criterion set for each period.

An example of label data generated by the label generating unit 12 will be described with reference to the lower view of FIG. 3. First, for partial time series data belonging to “normal period”, the label generating unit 12 sets a normal state certainty factor “1.0” and an anomalous state certainty factor “0.0” state at any time, and generates label data associated with the partial time series data. For partial time series data belonging to “anomalous period”, the label generating unit 12 sets a normal state certainty factor “0.0” and an anomalous state certainty factor “1.0” at any time, and generates label data associated with the partial time series data. At this time, the anomalous state certainty factor “1.0” is assumed to be an “anomalous value” representing the anomalous state. The time width, number, and slide width of the window w may be any values and, for example, may be set in the same manner as a time width and a slide width set in the “boundary period” to be described below. That is to say, the window w set in the “normal period” and the “anomalous period” may have a size W for three samples and a slide width S for two samples based on the number of samples of the time series data.

Then, the label generating unit 12 generates label data for partial time series data belonging to “boundary period” in the following manner. As an example, it is assumed that the time series data of the “boundary period” has, as shown in the upper of FIG. 4, a number B of samples is six (B=6), a size (time width) W of the window w is for three samples (W=3), and a slide width S in time direction of the window w is for two samples (S=2). In this case, the label generating unit 12 determines a number L of label data generated in the “boundary period” to be four (L=4) by the following Equation 1 using the abovementioned parameters.

$$L = floor [ \frac{B + W - 1}{S} ] = floor [ \frac{6 + 3 - 1}{2} ] = 4 \qquad [ Equation 1 ]$$

Subsequently, the label generating unit 12 generates four partial time series data corresponding to four label data from the time series data of the “boundary period”, and sets a weight of a category for each of the partial time series data and associates them. Since the partial time series data corresponding to the four label data of the boundary period generated here are time series data having a predetermined time width, and may include part of adjacent time series data of normal period or anomalous period. Then, the label generating unit 12 sets a value determined in accordance with a preset “function f(x)” with the passage of the time of the partial time series data as a weight of each category. For example, in a case where a “boundary period” is a period transiting from a “normal period” to an “anomalous period”, a function f(x) that determines a value representing the “weight” of category “anomalous state” is represented by Equation 2, where the sampling interval of time series data is At. It is assumed that “t” represents the start time of the boundary period.

$$f ( x ) = \frac{1}{Δ t ( B + W )} ( x - t ) \qquad [ Equation 2 ]$$

The value of the “weight” of category “anomalous state” determined in accordance with the time of each partial time series data configuring each label data in the boundary period by the above Equation 2 is shown in the lower view of FIG. 4. As shown in this view, the label generating unit 12 sets so that, as the time of the partial time series data configuring the label data in the boundary period comes closer to the anomalous period, the value of the “weight” of category “anomalous state” increases and comes closer to “anomalous value=1” that is the “weight” of category “anomalous state” set for the partial time series data of the anomalous period. In this view, “ΔT” represents the interval of label data, and is given by “ΔT=(B+W)/L”. Then, as shown in this view, “0.2” is set as the weight of the anomalous state for the partial time series data at time “t+ΔT” closest to the “normal period”, and the weight of the anomalous state is set so as to linearly increase such as “0.4”, “0.6” and “0.8” as the time comes closer to the “anomalous period”.

As described above, in this example embodiment, the function f(x) for determining the “weight” of category “anomalous state” is a monotonically increasing function whose value increases with the passage of the time of the partial time series data, and in particular, it is a linear function. However, the function f(x) may be another function such as a sigmoid function, and is not necessarily limited to an increasing function. For example, the function f(x) may be a function determining a value increasing or decreasing so as to come closer to the value of the “weight” of category “anomalous state” set for the partial time series data of the label data in the “anomalous period” with the passage of the time of the “boundary period”. Furthermore, the function f(x) may be a function whose value changes in any way in accordance with time until the “anomalous period” with the passage of the time of the “anomalous period”. The function f(x) is previously designated by the user and stored in the requirement storing unit 20.

The label generating unit 12 also sets the “weight” of category “normal state” for each partial time series data configuring each label data. In this example, it is set in contrast with the above f (x) so that, as the time of the partial time series data comes closer to the “anomalous period”, the value gradually decreases from the “weight=1” of “normal period”. That is to say, the “weight” of category “normal state” is determined by “1−f (x)”. In this example embodiment, a case of performing classifications of two categories “normal” and “anomalous” by supervised learning is described, and therefore, the weight of “normal state” and the weight of “anomalous state” are set in pair. However, the label generating unit 12 does not necessarily need to set the weight of the normal state.

Then, the label generating unit 12 stores label data generated for each period and including partial time series data and the weight of a category associated with the partial time series data into the label storing unit 18. The label generating unit 12 generates label data in the same manner as described above for other learning data stored in the measurement data storing unit 17, and stores the generated label data into the label storing unit 18.

The learning unit 13 (learning unit) retrieves label data from the label storing unit 18, and generates a model by performing learning of the label data. Specifically, the learning unit 13 performs machine learning to generate a model that takes partial time series data configuring label data as input data and outputs a set of “weight” of category “normal state” and “weight” of category “anomalous state” associated with the partial time series data as a teaching signal. That is to say, the learning unit 13 performs learning by using a teaching signal in which “weight (certainty factor) of normal state=1” and “weight (certainty factor) of anomalous state=0” for partial time series data of “normal period”, and performs learning by using a teaching signal in which “weight (certainty factor) of normal state=0” and “weight (certainty factor) of anomalous state=1” for partial time series data of “anomalous period”. Furthermore, the learning unit 13 performs learning by using a teaching signal in which the respective “weights (certainty factors)” of “normal state” and “anomalous state” are set to “values more than 0 and less than 1” for partial time series data of “boundary period” as described above.

Consequently, the model is configured to, when time series data measured from the measurement target P is input, output “weight=0” of category “anomalous state” in a case where the input time series data corresponds to time series data determined to be the normal state in the past, and output “weight=1” of category “anomalous state” in a case where the input time series data corresponds to time series data determined to be the anomalous state in the past. Moreover, the model is configured to output “weight=value more than 0 and less than 1” of “category “anomalous state” depending on time up to the anomalous period in a case where the input time series data corresponds to time series data determined to be the boundary state in the past.

The threshold value determining unit 14 (threshold value determining unit) uses label data stored in the label storing unit 18 to determine a threshold value to be used in predicting the state of the measurement target P by using the abovementioned model later. In this example embodiment, the threshold value determining unit 14 particularly sets a threshold value for detecting an indication that the measurement target P falls into an anomalous state. A temporal requirement until the measurement target P falls into an anomalous state is stored in the requirement storing unit 20 in advance, and a threshold value satisfying the requirement is determined.

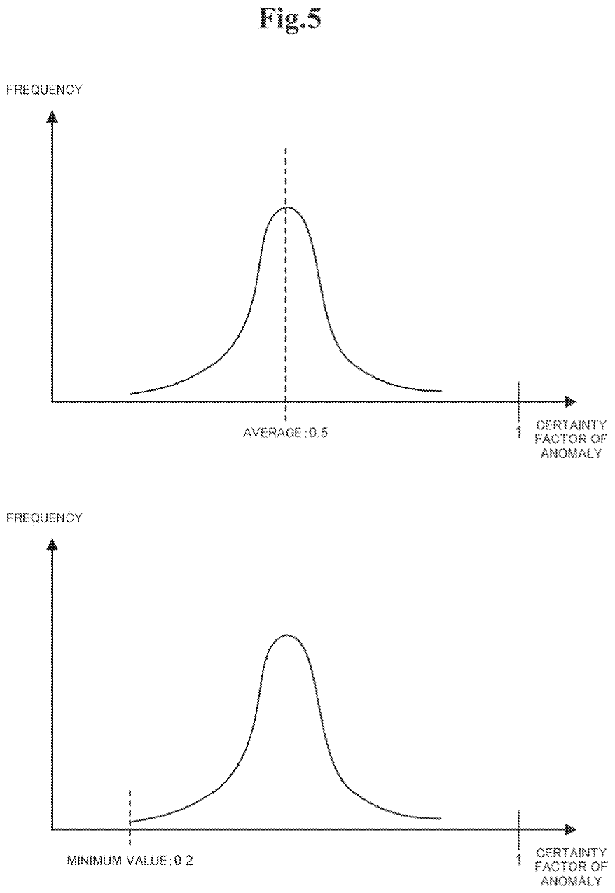

As an example, in a case where a temporal requirement “detect indication 10 seconds before falling into anomalous state on average” is set, as shown in the upper view of FIG. 5, the threshold value determining unit 14 first retrieves the “weight” of category “anomalous state” associated with partial time series data at a time 10 seconds before the “anomaly period” from among partial time series data configuring label data of the “boundary period”, and generates the statistic of the frequency thereof. Then, as shown in the upper view of FIG. 5, the threshold value determining unit 14 calculates the average value from the statistical information of the frequency of “weight”, and determines the calculated average value “0.5” as a threshold value.

Further, as another example, in a case where a temporal requirement “detect indication 10 seconds before falling into anomalous state” is set, in the same manner as described above, as shown in the lower view of FIG. 5, the threshold value determining unit 14 retrieves the “weight” of category “anomalous state” associated with partial time series data at a time 10 seconds before the “anomaly period” from among partial time series data configuring label data of the “boundary period”, and generates the statistic of the frequency thereof. Then, as shown in the lower view of FIG. 5, the threshold value determining unit 14 determines the minimum value “0.2” of “weight” as a threshold value.

The predicting unit 15 (detecting unit) acquires newly measured time series data from the measurement target P, and predicts the state of the measurement target P by using the model generated as described above. Specifically, the predicting unit 15 first retrieves the model stored in the model storing unit 19, acquires time series data newly measured by the measuring unit 11 from the measurement target P, and inputs partial time series data having a predetermined time width of the time series data into the model. Then, the predicting unit 15 acquires the value of the “weight” of category “anomalous state” corresponding to the input partial time series data as a value output from the model, and predicts the value of the weight as the state of the measurement target P. Then, the predicting unit 15 passes the acquired value of the weight to the determining unit 16.

The determining unit (detecting unit) determines the state of the measurement target P based on the value of the “weight” of category “anomalous state” output from the model corresponding to the time series data measured from the measurement target P as described above. Specifically, the determining unit 16 determines that the measurement target P is in the normal state when the value of the weight is “0”, and determines that the measurement target P is in the anomalous state when the value of the weight is “1”. Moreover, when the value of the weight is “more than 0 and less than 1”, the determining unit 16 compares the value of the weight with the threshold value. Then, when the value of the weight is equal to or more than the threshold value, the determining unit 16 determines detection of an indication that the measurement target P falls into the anomalous state. The determining unit 16 may determine that the measurement target P is in the “anomalous state” when the value of the weight is equal to or more than the threshold value as a result of comparison between the value of the weight and the threshold value, and determine that the measurement target P is in the “normal state” when the value of the weight is less than the threshold value as a result of the comparison.

Then, the determining unit 16 performs a process corresponding to the determination result. For example, when determining detection of the indication that the measurement target P falls into the anomalous state, the determining unit 16 notifies it to a preset notification destination such as an administrator.

The threshold value determining unit 14 described above may determine a threshold value by a method different from the above. For example, the threshold value determining unit 14 requests the predicting unit 15 described above to input time series data that is learning data to become the generation source of label data stored in the measurement data storing unit 17 into the model, and acquires the value of the “weight” of category “anomalous state” that is the output therefrom. In particular, the threshold value determining unit 14 requests the predicting unit 15 to input partial time series data configuring label data of the boundary period into the model, and acquires the “weight” of category “anomalous state” that is the output therefrom. Then, as shown in FIG. 5, in the same manner as described above, the threshold value determining unit 14 generates the statistic of the frequency of “weight” of a predetermined time in accordance with a temporal requirement until the measurement target P falls into the anomalous state (for example, detect indication 10 seconds before falling into anomalous state), and determines the threshold value based on the statistical information. However, the threshold value determining unit 14 may determine the threshold value by any method.

### [Operation]

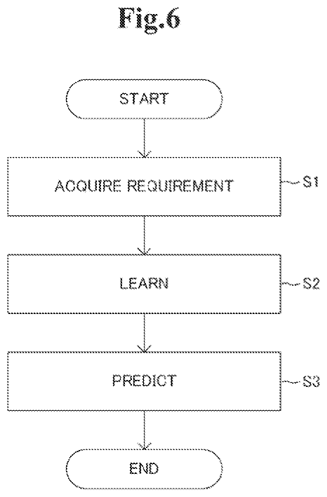

Next, an operation of the time series data processing system 10 having the abovementioned configuration will be described with reference to flowcharts shown in FIGS. 6 to 12. First, the time series data processing system 10 acquires a detection requirement input by, for example, the administrator of the measurement target P, and stores the detection requirement into the requirement storing unit 20 (step S1 of FIG. 6). The detection requirement is, for example, information representing a criterion for determining the “weight” of category “anomalous state” to be associated with partial time series data at the time of generating label data as described above, and in particular, information of a function f(x) determining a weight to be associated with partial time series data of “boundary period”. Moreover, the detection requirement is information representing a requirement for detecting an indication of an anomalous state at the time of predicting the state of the measurement target P, and in particular, a temporal requirement to detect an indication that the measurement target P falls into an anomalous state. Furthermore, the detection requirement is information necessary for generating label data as will be described above, and is, for example, information such as a size W of a window w with respect to the number of samples of time series data, a slide width S, and an equation for calculating the number of label data.

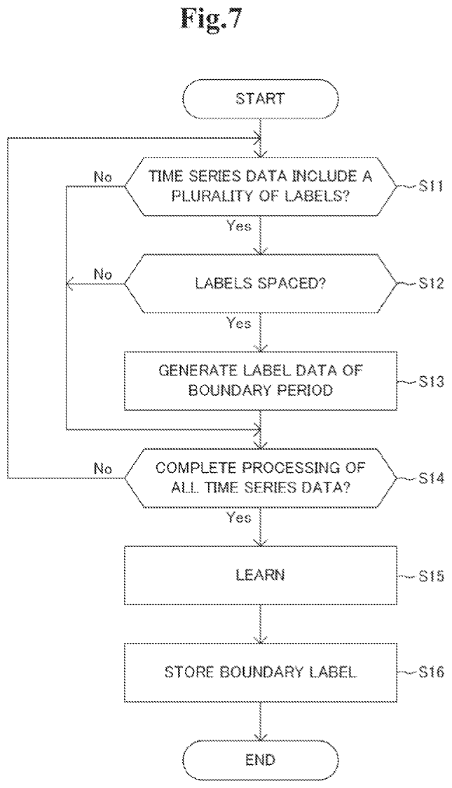

Subsequently, the time series data processing system 10 performs learning of time series data acquired as learning data from the measurement target P (step S2 of FIG. 6). The details of the learning operation by the time series data processing system 10 will be described with reference to the flowcharts of FIGS. 7 to 9.

First, the time series data processing system 10 retrieves time series data that is learning data, and checks whether the time series data includes a plurality of set labels (step S11 of FIG. 7). Then, in a case where, for example, as shown in the lower view of FIG. 2, the time series data includes a plurality of labels such as a label of normal period and a label of anomalous period (step S11 of FIG. 7, Yes) and the labels are spaced (step S12 of FIG. 7, Yes), the time series data processing system 10 sets a label of boundary period to time series data between the labels. Then, the time series data processing system 10 generates label data for the time series data of the boundary period (step S13 of FIG. 7).

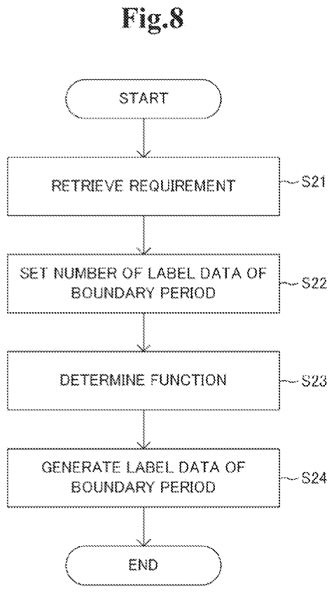

Specifically, the time series data processing system 10 generates label data of the boundary period as shown in the flowchart of FIG. 8. First, the time series data processing system 10 retrieves requirement information necessary for generating label data from the requirement storing unit 20 (step S21 of FIG. 8), and sets the number of label data to be generated in the boundary period by using the requirement information (step S22 of FIG. 8). Then, the time series data processing system 10 determines a function f(x) determining the “weight” of category “anomalous state” to be associated with each of partial time series data configuring label data of the boundary period (step S23 of FIG. 8), and generates the label data by associating each of the partial time series data with the “weight” (step S24 of FIG. 8). The time series data processing system 10 also generates label data for time series data of the normal period and time series data of the anomalous period. In this manner, the time series data processing system 10 generates the label data of the respective periods as shown in the lower view of FIG. 3 and the lower view of FIG. 4.

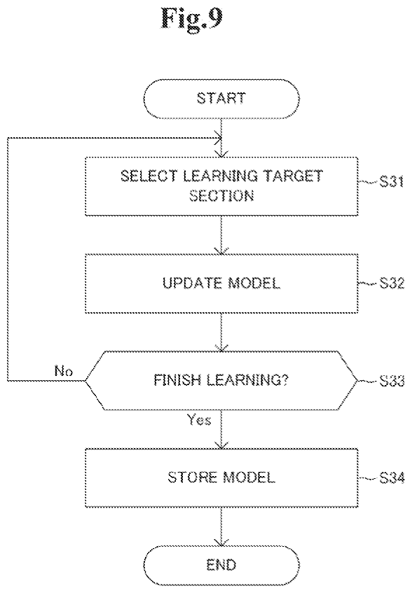

Then, the time series data processing system 10 selects a section to be a learning target, such as the normal period, the anomalous period or the boundary period, from the time series data that is the learning data (step S31 of FIG. 9), and performs machine learning by using the label data of the section. Specifically, the time series data processing system 10 performs machine learning so as to generate a model that takes partial time series data configuring label data as input data and outputs the “weight” of category “anomalous state” associated with the partial time series data as a teaching signal, and updates the model as needed (step S32 of FIG. 9). When finishing the machine learning (step S33 of FIG. 9, Yes), the time series data processing system 10 stores the model into the model storing unit 19. In the above manner, the time series data processing system 10 performs learning (step S15 of FIG. 7), and stores the generated label data into the label storing unit 18 (step S16 of FIG. 7).

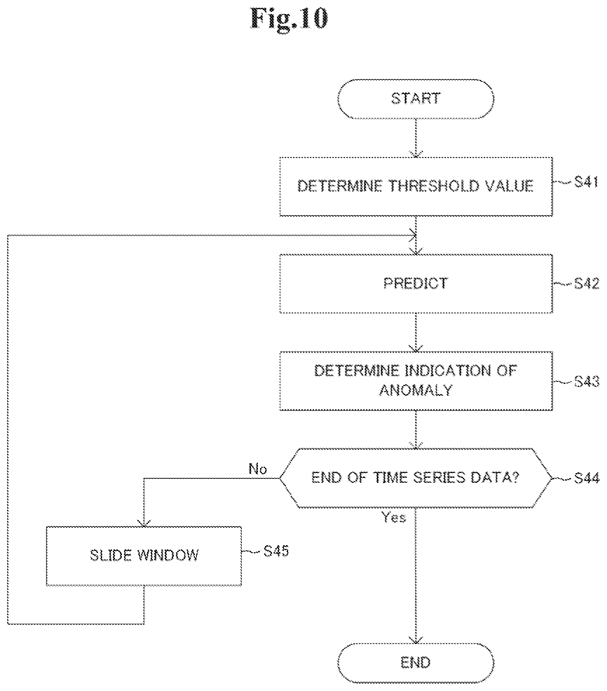

After that, the time series data processing system 10 predicts the state of the measurement target P by using the generated model (step S3 of FIG. 6). Specifically, the time series data processing system 10 detects an indication that the measurement target P falls into the anomalous state as shown in the flowchart of FIG. 10. The time series data processing system 10 first determines a threshold value to be compared with a value output by the model as will be described later (step S41 of FIG. 10).

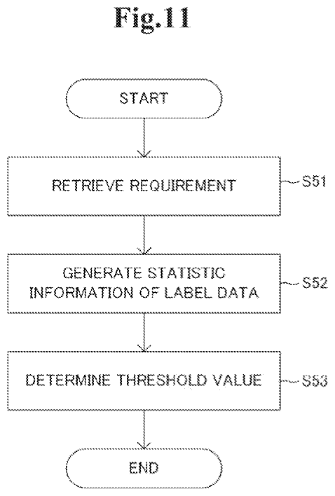

In order to determine the threshold value, the time series data processing system 10 first retrieves requirement information (step S51 of FIG. 11), and also retrieves the label data of the boundary period. Then, the time series data processing system 10 generates the statistic of the frequency of the “weight” of category “anomalous state” associated with partial time series data at a time corresponding to the requirement information (step S52 of FIG. 11). Then, the time series data processing system 10 determines a threshold value corresponding to the requirement information based on the statistic information of the frequency of the “weight” (step S53 of FIG. 11). As an example, in a case where requirement information “detect indication 10 seconds before falling into anomalous state on average” is set, the time series data processing system 10 first generates the statistic of the frequency of the “weight” of category “anomalous state” associated with partial time series data at a time 10 seconds before the “anomalous state” from among the partial time series data configuring the label data of the “boundary period” as shown in the upper view of FIG. 5. Then, the time series data processing system 10 calculates the average value from the statistic information of the frequency of the “weight”, and determines the calculated average value “0.5” as the threshold value.

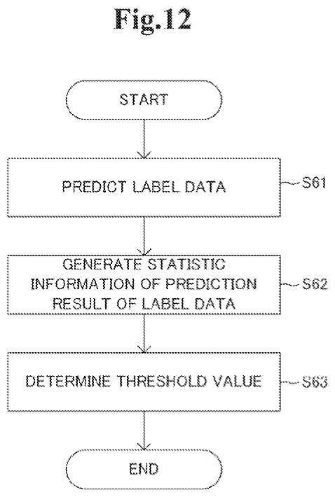

However, the time series data processing system 10 may determine a threshold value by another method as shown in the flowchart shown in FIG. 12. The time series data processing system 10 first retrieves the requirement information (step S61 of FIG. 12), also retrieves the label data of the boundary period and the model, inputs partial time series data configuring the label data of the boundary period into the model, and acquires the output value thereof. Then, the time series data processing system 10 uses the output value from the model like the “weight” included in the label data described above. That is to say, the time series data processing system 10 generates the statistic of the frequency of the output value using the partial time series data at the time corresponding to the requirement information as an input (step S62 of FIG. 12). Then, the time series data processing system 10 determines a threshold value corresponding to the requirement information based on the statistic information of the frequency of the output value (step S63 of FIG. 12).

Subsequently, the time series data processing system 10 acquires time series data newly measured from the measurement target P, and predicts the state of the measurement target P by using the model generated as described above (step S42 of FIG. 10). Specifically, the time series data processing system 10 sets a window w having a predetermined time width on the measured time series data, inputs partial time series data within the window w into the model, and acquires an output value from the model, that is, the value of the “weight” of category “anomalous state” corresponding to the input partial time series data. Then, the time series data processing system 10 compares the output value with the threshold value and, in a case where the output value is equal to or more than the threshold value, determines detection of an indication that the measurement target P falls into the anomalous state (step S43 of FIG. 10). The time series data processing system 10 performs the abovementioned prediction process while sliding the window w set on the time series data until the end of the time series data (steps S44 and S45 of FIG. 10).

As described above, the time series data processing system 10 according to the present invention makes it possible to more properly detect an indication that the measurement target P falls into the anomalous state. In particular, even if the boundary period between the normal period and the anomalous period of the measurement target P is long, it is possible to detect a desired timing before the measurement target P falls into the anomalous state.

### Second Example Embodiment

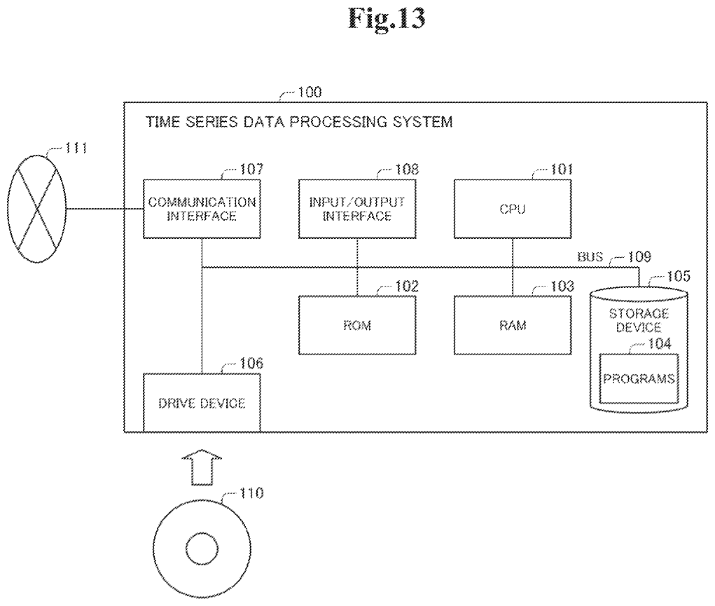

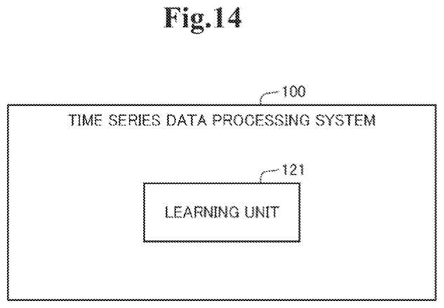

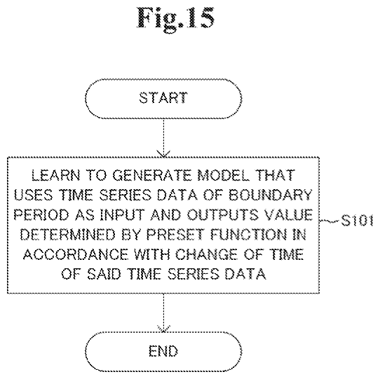

Next, a second example embodiment of the present invention will be described with reference to FIGS. 13 to 15. FIGS. 13 to 14 are block diagrams showing a configuration of a time series data processing system in the second example embodiment, and FIG. 15 is a flowchart showing an operation of the time series data processing system. This example embodiment shows the overview of the configurations of the time series data processing system described in the above example embodiment and a time series data processing method.

First, a hardware configuration of a time series data processing system 100 in this example embodiment will be described with reference to FIG. 13. The time series data processing system 100 is configured by a general information processing apparatus and, as an example, includes a hardware configuration as shown below;

a CPU (Central Processing Unit) 101 (arithmetic logic unit),

a ROM (Read Only Memory) 102 (storage unit),

a RAM (Random Access Memory) 103 (storage unit),

programs 104 loaded to the RAM 103,

a storage device 105 for storing the programs 104,

a drive device 106 reading from and writing into a storage medium 110 outside the information processing apparatus,

a communication interface 107 connected to a communication network 111 outside the information processing apparatus,

an input/output interface 108 performing input and output of data, and

a bus 109 connecting the respective components.

Then, the time series data processing apparatus 100 can structure and include a learning unit 121 shown in FIG. 14 by the CPU 101 acquiring and executing the programs 104. The programs 104 are, for example, stored in the storage device 105 or the ROM 102 in advance, and the CPU 101 loads to the RAM 103 and executes as necessary. Alternatively, the programs 104 may be supplied to the CPU 101 via the communication network 111, or may be stored in the storage medium 110 in advance and retrieved and supplied to the CPU 101 by the drive device 106. The abovementioned learning unit 121 may be structured by an electronic circuit.

FIG. 13 shows an example of the hardware configuration of the information processing apparatus serving as the time series data processing apparatus 100, and the hardware configuration of the information processing apparatus is not limited to the abovementioned case. For example, the information processing apparatus may be configured by part of the above configuration, such as excluding the drive device 106.

The time series data processing apparatus 100 executes a time series data processing method shown in the flowchart of FIG. 15 by a function of the learning unit 121 structured by the programs as described above.

As shown in FIG. 15, the time series data processing system 100 performs learning so as to generate a model which takes, as an input, boundary period time series data of time series data measured from a measurement target, which is time series data of a boundary period between a normal period that is a period in which the measurement target is determined to be in a normal state and an anomalous period that is a period when the measurement target is determined to be in an anomalous state, and which outputs a teaching signal determined by a preset function in accordance with change of time of the boundary period time series data (step S101).

According to the present invention, as described above, a model is generated which takes, as an input, boundary period time series data that is time series data of a boundary period in which the measurement target is in a state between a normal period and an anomalous period, and which outputs a teaching signal determined by a preset function in accordance with change of time of the boundary period time series data. Therefore, by inputting time series data newly measured from the measurement target into the model, it is possible to obtain an output value corresponding to change of time of the boundary period, and it is possible to more properly detect an indication of an anomalous state based on the output value.

### <Supplementary Notes>

The whole or part of the example embodiments disclosed above can be described as the following supplementary notes. Below, the overview of configurations of a time series data processing method, a time series data processing apparatus, and a program according to the present invention will be described. However, the present invention is not limited to the following configurations.
(Supplementary Note 1)

A time series data processing method comprising

learning so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data, the normal period being a period in which the measurement target is determined to be in a normal state, the anomalous period being a period in which the measurement target is determined to be in an anomalous state.
(Supplementary Note 2)

The time series data processing method according to Supplementary Note 1, comprising:

generating label data in which the teaching signal corresponding to a state of the measurement target is associated with partial time series data including the time series data having a predetermined time width, and also generating the label data in which the teaching signal determined by the function set for the boundary period in accordance with change of time of the boundary period time series data is associated with the partial time series data within the boundary period time series data; and

learning by using the label data to generate the model.
(Supplementary Note 3)

The time series data processing method according to Supplementary Note 2, comprising generating the label data by associating a value determined by the function so as to get closer to a value of the teaching signal associated with the partial time series data within the anomalous period as the partial time series data within the boundary period time series data gets closer to the anomalous period from the normal period, as the teaching signal, with the partial time series data within the boundary period time series data.
(Supplementary Note 4)

The time series data processing method according to Supplementary Note 3, comprising

generating the label data by associating an anomaly value representing the anomalous state, as the teaching signal, with the partial time series data within the anomalous period, and also generating the label data by associating a value determined by the function so as to get closer to the anomaly value as the partial time series data within the boundary period time series data gets closer to the anomalous period from the normal period, as the teaching signal, with the partial time series data within the boundary period time series data.
(Supplementary Note 5)

The time series data processing method according to Supplementary Note 4, comprising

generating the label data by associating a value lower than the anomaly value, as the teaching signal, with the partial time series data within the normal period, and also generating the label data by associating a value determined by the function so as to increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.
(Supplementary Note 6)

The time series data processing method according to Supplementary Note 5, comprising

generating the label data by associating a value determined by the function so as to monotonically increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.
(Supplementary Note 7)

The time series data processing method according to any of Supplementary Notes 1 to 6, comprising

inputting time series data newly measured from the measurement target into the generated model, and detecting an indication that the measurement target gets into the anomalous state based on a value output from the model.
(Supplementary Note 8)

The time series data processing method according to any of Supplementary Notes 2 to 6, comprising:

setting a threshold value based on the label data generated from the boundary period time series data and time for the anomalous period of the partial time series data configuring the label data; and

inputting time series data newly measured from the measurement target into the generated model, and detecting an indication that the measurement target gets into the anomalous state based on a result of comparison between a value output from the model and the threshold value.
(Supplementary Note 9)

The time series data processing method according to Supplementary Note 8, comprising

setting the threshold value based on the teaching signal associated with, of the partial time series data configuring the label data generated from the boundary period time series data, the partial time series data for preset time up to the anomalous period.
(Supplementary Note 10)

The time series data processing method according to Supplementary Note 8, comprising

inputting the partial time series data configuring the label data generated from the boundary period time series data into the model, and setting the threshold value based on a value output from the model.
(Supplementary Note 11)

A time series data processing system comprising

a learning unit configured to learn so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data, the normal period being a period in which the measurement target is determined to be in a normal state, the anomalous period being a period in which the measurement target is determined to be in an anomalous state.
(Supplementary Note 12)

The time series data processing system according to Supplementary Note 11, comprising

a generating unit configured to generate label data in which the teaching signal corresponding to a state of the measurement target is associated with partial time series data including the time series data having a predetermined time width, and also generate the label data in which the teaching signal determined by the function set for the boundary period in accordance with change of time of the boundary period time series data is associated with the partial time series data within the boundary period time series data,

wherein the learning unit is configured to learn by using the label data to generate the model.
(Supplementary Note 13)

The time series data processing system according to Supplementary Note 12, wherein

the generating unit is configured to generate the label data by associating a value determined by the function so as to get closer to a value of the teaching signal associated with the partial time series data within the anomalous period as the partial time series data within the boundary period time series data gets closer to the anomalous period from the normal period, as the teaching signal, with the partial time series data within the boundary period time series data.
(Supplementary Note 14)

The time series data processing system according to Supplementary Note 13, wherein

the generating unit is configured to generate the label data by associating an anomaly value representing the anomalous state, as the teaching signal, with the partial time series data within the anomalous period, and also generate the label data by associating a value determined by the function so as to get closer to the anomaly value as the partial time series data within the boundary period time series data gets closer to the anomalous period from the normal period, as the teaching signal, with the partial time series data within the boundary period time series data.
(Supplementary Note 15)

The time series data processing system according to Supplementary Note 14, wherein

the generating unit is configured to generate the label data by associating a value lower than the anomaly value, as the teaching signal, with the partial time series data within the normal period, and also generate the label data by associating a value determined by the function so as to increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.
(Supplementary Note 16)

The time series data processing system according to Supplementary Note 15, wherein

the generating unit is configured to generate the label data by associating a value determined by the function so as to monotonically increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.
(Supplementary Note 17)

The time series data processing system according to any of Supplementary Notes 11 to 16, comprising

a detecting unit configured to input time series data newly measured from the measurement target into the generated model, and detect an indication that the measurement target gets into the anomalous state based on a value output from the model.
(Supplementary Note 18)

The time series data processing system according to any of Supplementary Notes 12 to 16, comprising:

a threshold value setting unit configured to set a threshold value based on the label data generated from the boundary period time series data and time for the anomalous period of the partial time series data configuring the label data; and

a detecting unit configured to input time series data newly measured from the measurement target into the generated model, and detect an indication that the measurement target gets into the anomalous state based on a result of comparison between a value output from the model and the threshold value.
(Supplementary Note 19)

The time series data processing system according to Supplementary Note 18, wherein

the threshold value setting unit is configured to set the threshold value based on the teaching signal associated with, of the partial time series data configuring the label data generated from the boundary period time series data, the partial time series data for preset time up to the anomalous period.
(Supplementary Note 20)

The time series data processing system according to Supplementary Note 18, wherein

the threshold value setting unit is configured to input the partial time series data configuring the label data generated from the boundary period time series data into the model, and set the threshold value based on a value output from the model.
(Supplementary Note 21)

A computer program comprising instructions for causing an information processing apparatus to realize

a learning unit configured to learn so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data, the normal period being a period in which the measurement target is determined to be in a normal state, the anomalous period being a period in which the measurement target is determined to be in an anomalous state.
(Supplementary Note 22)

The computer program according to Supplementary Note 21, comprising instructions for causing the information processing apparatus to further realize

a generating unit configured to generate label data in which the teaching signal corresponding to a state of the measurement target is associated with partial time series data including the time series data having a predetermined time width, and also generate the label data in which the teaching signal determined by the function set for the boundary period in accordance with change of time of the boundary period time series data is associated with the partial time series data within the boundary period time series data,

wherein the learning unit is configured to learn by using the label data to generate the model.
(Supplementary Note 23)

The computer program according to Supplementary Note 22, comprising instructions for causing the information processing apparatus to further realize:

a threshold value setting unit configured to set a threshold value based on the label data generated from the boundary period time series data and time for the anomalous period of the partial time series data configuring the label data; and

a detecting unit configured to input time series data newly measured from the measurement target into the generated model, and detect an indication that the measurement target gets into the anomalous state based on a result of comparison between a value output from the model and the threshold value.

The abovementioned program can be stored by using various types of non-transitory computer-readable mediums and supplied to a computer. The non-transitory computer-readable mediums include various types of tangible storage mediums. Examples of the non-transitory computer-readable mediums include a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory)). Moreover, the program may be supplied to a computer by various types of transitory computer-readable mediums. Examples of the transitory computer-readable mediums include an electric signal, an optical signal, and an electromagnetic wave. The transitory computer-readable medium can supply the program to a computer via a wired communication path such as an electric wire and an optical fiber or via a wireless communication path.

Although the present invention has been described above with reference to the example embodiments and so on, the present invention is not limited to the above example embodiments. The configurations and details of the present invention can be changed in various manners that can be understood by one skilled in the art within the scope of the present invention. Moreover, at least one or more of the functions of the measuring unit, the label generated unit, the learning unit, the threshold value determining unit, the predicting unit, the determining unit, the measurement data storing unit, the label storing unit, the model storing unit, and the requirement storing unit described above may be executed by an information processing apparatus installed in any place on a network and connected thereto, that is, may be executed on so-called cloud computing.

### DESCRIPTION OF NUMERALS

10 time series data processing system
11 measuring unit
12 label generating unit
13 learning unit
14 threshold value determining unit
15 predicting unit
16 determining unit
17 measurement data storing unit
18 label storing unit
19 model storing unit
20 requirement storing unit
100 time series data processing system
101 CPU
102 ROM
103 RAM
104 programs
105 storage device
106 drive device
107 communication interface
108 input/output interface
109 bus
110 storage medium
111 communication network
121 learning unit

What is claimed is:

1. A time series data processing method comprising
learning so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data, the normal period being a period in which the measurement target is determined to be in a normal state, the anomalous period being a period in which the measurement target is determined to be in an anomalous state.

2. The time series data processing method according to claim 1, comprising:
generating label data in which the teaching signal corresponding to a state of the measurement target is associated with partial time series data including the time series data having a predetermined time width, and also generating the label data in which the teaching signal determined by the function set for the boundary period in accordance with change of time of the boundary period time series data is associated with the partial time series data within the boundary period time series data; and
learning by using the label data to generate the model.

3. The time series data processing method according to claim 2, comprising
generating the label data by associating a value determined by the function so as to get closer to a value of the teaching signal associated with the partial time series data within the anomalous period as the partial time series data within the boundary period time series data gets closer to the anomalous period from the normal period, as the teaching signal, with the partial time series data within the boundary period time series data.

4. The time series data processing method according to claim 3, comprising
generating the label data by associating an anomaly value representing the anomalous state, as the teaching signal, with the partial time series data within the anomalous period, and also generating the label data by associating a value determined by the function so as to get closer to the anomaly value as the partial time series data within the boundary period time series data gets closer to the anomalous period from the normal period, as the teaching signal, with the partial time series data within the boundary period time series data.

5. The time series data processing method according to claim 4, comprising
generating the label data by associating a value lower than the anomaly value, as the teaching signal, with the partial time series data within the normal period, and also generating the label data by associating a value determined by the function so as to increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.

6. The time series data processing method according to claim 5, comprising
generating the label data by associating a value determined by the function so as to monotonically increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.

7. The time series data processing method according to claim 1, comprising
inputting time series data newly measured from the measurement target into the generated model, and detecting an indication that the measurement target gets into the anomalous state based on a value output from the model.

8. The time series data processing method according to claim 2, comprising:
setting a threshold value based on the label data generated from the boundary period time series data and time for the anomalous period of the partial time series data configuring the label data; and
inputting time series data newly measured from the measurement target into the generated model, and detecting an indication that the measurement target gets into the anomalous state based on a result of comparison between a value output from the model and the threshold value.

9. The time series data processing method according to claim 8, comprising
setting the threshold value based on the teaching signal associated with, of the partial time series data configuring the label data generated from the boundary period time series data, the partial time series data for preset time up to the anomalous period.

10. The time series data processing method according to claim 8, comprising
inputting the partial time series data configuring the label data generated from the boundary period time series data into the model, and setting the threshold value based on a value output from the model.

11. A time series data processing system comprising:
at least one memory configured to store instructions; and
at least one processor configured to execute the instructions to:
learn so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data, the normal period being a period in which the measurement target is determined to be in a normal state, the anomalous period being a period in which the measurement target is determined to be in an anomalous state.

12. The time series data processing system according to claim 11, wherein the at least one processor is configured to execute the instructions to:
generate label data in which the teaching signal corresponding to a state of the measurement target is associated with partial time series data including the time series data having a predetermined time width, and also generate the label data in which the teaching signal determined by the function set for the boundary period in accordance with change of time of the boundary period time series data is associated with the partial time series data within the boundary period time series data; and
learn by using the label data to generate the model.

13. The time series data processing system according to claim 12, wherein the at least one processor is configured to execute the instructions to
generate the label data by associating a value determined by the function so as to get closer to a value of the teaching signal associated with the partial time series data within the anomalous period as the partial time series data within the boundary period time series data gets closer to the anomalous period from the normal period, as the teaching signal, with the partial time series data within the boundary period time series data.

14. The time series data processing system according to claim 13, wherein the at least one processor is configured to execute the instructions to
generate the label data by associating an anomaly value representing the anomalous state, as the teaching signal, with the partial time series data within the anomalous period, and also generate the label data by associating a value determined by the function so as to get closer to the anomaly value as the partial time series data within the boundary period time series data gets closer to the anomalous period from the normal period, as the teaching signal, with the partial time series data within the boundary period time series data.

15. The time series data processing system according to claim 14, wherein the at least one processor is configured to execute the instructions to
generate the label data by associating a value lower than the anomaly value, as the teaching signal, with the partial time series data within the normal period, and also generate the label data by associating a value determined by the function so as to increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.

16. The time series data processing system according to claim 15, wherein the at least one processor is configured to execute the instructions to
generate the label data by associating a value determined by the function so as to monotonically increase toward the anomaly value from a value associated as the teaching signal with the partial time series data of the normal period as the partial time series data within the boundary period time series data gets closer to the anomalous period from the normal period, as the teaching signal, with the partial time series data within the boundary period time series data.

17. The time series data processing system according to claim 11, wherein the at least one processor is configured to execute the instructions to
input time series data newly measured from the measurement target into the generated model, and detect an indication that the measurement target gets into the anomalous state based on a value output from the model.

18. The time series data processing system according to claim 12, wherein the at least one processor is configured to execute the instructions to:
set a threshold value based on the label data generated from the boundary period time series data and time for the anomalous period of the partial time series data configuring the label data; and
input time series data newly measured from the measurement target into the generated model, and detect an indication that the measurement target gets into the anomalous state based on a result of comparison between a value output from the model and the threshold value.

19. The time series data processing system according to claim 18, wherein the at least one processor is configured to execute the instructions to
set the threshold value based on the teaching signal associated with, of the partial time series data configuring the label data generated from the boundary period time series data, the partial time series data for preset time up to the anomalous period.

20. (canceled)

21. A non-transitory computer-readable storage medium having a program stored therein, the program comprising instructions for causing an information processing apparatus to execute
a process to learn so as to generate a model that takes, of time series data measured from a measurement target, boundary period time series data that is time series data of a boundary period between a normal period and an anomalous period as an input and outputs a teaching signal determined by a preset function in accordance with change of time of the boundary period time series data, the normal period being a period in which the measurement target is determined to be in a normal state, the anomalous period being a period in which the measurement target is determined to be in an anomalous state.

22-23. (canceled)
